(19) United States
(12) Patent Application Publication
(10) Pub. No.: US 2013/0271477 A1
(43) Pub. Date: Oct. 17, 2013

(54) METHOD FOR MANAGING MEMORY AND IMAGE DISPLAY DEVICE FOR SAME

(71) Applicant: Eunkyung Shin, Seoul (KR)

(72) Inventor: Eunkyung Shin, Seoul (KR)

(73) Assignee: LG ELECTRONICS INC., Seoul (KR)

(21) Appl. No.: 13/994,236

(22) PCT Filed: Oct. 11, 2011
(86) PCT No.: PCT/KR2011/007507

§ 371 Date: Jun. 14, 2013

Related U.S. Application Data
(60) Provisional application No. 61/423,253, filed on Dec. 15, 2010.

(30) Foreign Application Priority Data
Jan. 13, 2011 (KR) 1020110003733
Oct. 5, 2011 (KR) 1020110101492

(51) Int. Cl. G06T 1/60

(52) U.S. Cl. CPC G06T 1/60
USPC 345/531

(57) ABSTRACT

The method for managing memory according to the plurality of accounts in an image display device includes: obtaining memory management data according to the plurality of accounts; obtaining information on one account when a command for storing data, which are selected while logged on to the one account, is inputted; and displaying a memory management menu accordingly. The storage space of an image display device may be used to ensure usage efficiency for a user using a plurality of accounts.

### TECHNICAL FIELD

The present disclosure relates to an image display device and a method of managing a memory by using the same, and more particularly, allocates and managing an available memory for a plurality of accounts to enable resources of the image display device to be efficiently used.

### BACKGROUND ART

An image display device is a device that has, for example, functions of receiving and processing a broadcasting image viewable by a viewer. The image display device displays, for example, a broadcasting program selected by a user that corresponds to one of broadcasting signals transmitted from a broadcasting station. Currently, the transition from an analog broadcast to a digital broadcast is being globally made.

The digital broadcast indicates broadcast for transmitting a digital image and audio signal. The digital broadcast has less data loss, is easy to correct an error, has high resolution and provides a clear screen as compared to the analog broadcast, because the digital broadcast is resistant to external noise. In addition, the digital broadcast may provide a bidirectional service, unlike the analog broadcast.

The image display device has been enhanced in performance and has diversified in function to provide the digital broadcast including a lot of content. In addition, the enhanced performance of the image display device allows a user to receive an image signal from the broadcasting station and view a related broadcasting program, and further, the image display device may perform various functions such as game and music play functions, and an internet shopping function by using various applications.

The image display device enables various applications to be downloaded and used and favorite applications may be different per individual. A multi-user image display device needs to download and execute applications by account. The image display device may provide and manage a login menu by account but, some image display devices restrict the number of accounts. In this case, one of a plurality of accounts may download applications and use up a memory that has a finite capacity. This may weaken the intents of creating a login menu by account and restricting the number of accounts.

### DISCLOSURE OF THE INVENTION

### Technical Problem

Embodiments provide a memory management menu through which a storage capacity available by account is set to overcome the above-described limitations and storage capacities according to a plurality of accounts are managed.

The present invention may inform of whether a download operation may be made for an account, by using memory managing data when a user attempts to downloads data for that account. In addition, the present invention may induce a user to make a download operation with other accounts that have relatively great storage capacities, thereby enabling an efficient memory management.

### Technical Solution

In one embodiment, a method of managing a memory according to a plurality of accounts on an image display device includes obtaining memory management data according to the plurality of accounts; receiving a command to store selected data while logged in using the one account; obtaining information regarding the one account; and displaying a memory management menu according to information regarding the one account.

In another embodiment, an image display device for managing a memory according to a plurality of accounts includes a storage unit storing memory management data according to the plurality of accounts; an user interface unit receiving a command to store selected data while logged in using the one account; a control unit obtaining information regarding the one account from the memory management data and displaying a memory management menu according to information regarding the one account.

### Advantageous Effects

According to the present invention, since a memory is allocated and used by account, it is possible to prevent one account to exclusively use the memory and thus promote harmony between family members.

In addition, according to the present invention, since when a storage capacity for one account is insufficient, storage capacities for other accounts may be used with reference to other accounts, it is possible to prevent a lack of memory or idle memory.

### BRIEF DESCRIPTION OF THE DRAWINGS

FIG. 1 is a schematic view of a broadcasting system according to an embodiment;

FIG. 2 is a schematic view of a broadcasting system according to another embodiment;

FIG. 3 represents a method of receiving/transmitting data between an image display device and a service provider according to an embodiment;

FIG. 4 is a schematic block diagram of an image display device according to an embodiment of the present invention;

FIG. 5 is a schematic block diagram of an image display device according to another embodiment of the present invention;

FIG. 6 is a graph of a memory usage state by account of an image display device;

FIG. 7 is a graph of a memory usage state of memory management data according to an embodiment of the present invention;

FIG. 8 is a graph of a memory usage state of memory management data according to another embodiment of the present invention;

FIG. 9 is a graph of a memory usage state of memory management data according to another embodiment of the present invention;

FIG. 10A is an exemplary screen of how to select data to be downloaded by a user;

FIG. 10B is an exemplary screen of how to inform a user of a memory usage state by using memory management data;

FIG. 10C is an exemplary screen of how to inform of a lack of memory of one account;

FIG. 10D is an exemplary screen of how to display a memory inform menu 80 along with an application list screen;

FIG. 10E is a screen of an image display device according to another embodiment of the present invention;

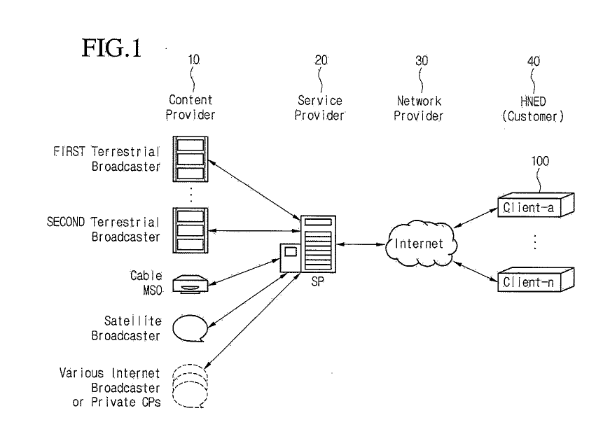

FIG. 1OF is an exemplary screen of how to enter a data store command according to an embodiment of the present invention;

FIG. 11A is a memory management menu according to an embodiment of the present invention;

FIG. 11B is an example of a login menu using another account; and

FIG. 12 is a flow chart of a method of managing a memory according to an embodiment of the present invention.

### MODE FOR CARRYING OUT THE INVENTION

The present invention will be described below in more detail with reference to the accompanying drawings.

The postfix “module” and “unit” for the components used in the following descriptions are simply given considering the ease of the writing of the specification and the “module” and “unit” may be interchanged in use.

An image display device to be described in the specification is an intelligent image display device which includes, for example, a computer assisted function in addition to a broadcast receiving function. Since the image display device includes an internet function in addition to the broadcast receiving function, it may have an interface convenient to use such as a handwritten-type input unit, a touch screen, or a space remote control unit. In addition, the image display device may be connected to the internet and a computer with the aid of a wired or wireless internet function and perform an email, web-browsing, banking or game function. A standardized general-purpose operating system (OS) may be used for such various functions.

Since the image display device to be described in the disclosure may freely add or delete various applications to/from, for example, a general-purpose OS kernel, it may perform various user friendly functions. The image display device may be, more particularly, a network TV, HBBTV, smart TV and in some cases, may also be applicable to a smart phone.

Further, although embodiments of the present invention will be described below with reference to the accompanying drawings and descriptions on the accompanying drawings, the present invention is not restricted or limited by the embodiments.

The terms used in the specification has been selected as general terms currently widely used if possible considering the functions in the present disclosure, but they may depend on the intentions of those skilled in the art, practice, the appearance of new technologies, etc. In addition, specific cases use the terms selected arbitrarily by the applicant and in these cases, their meaning will be described when describing corresponding inventions. Thus, it should be noted that the terms used in the specification should be construed on the basis of their actual meanings and contents through the specification, not just names thereof.

FIG. 1 is a schematic view of a broadcasting system according to an embodiment, and schematically represents an example of the entire broadcasting system that includes an image display device according to an embodiment of the present invention.

Referring to FIG. 1, a broadcasting system may divided into a content provider (CP) 10, a service provider (SP) 20, a network provider (NP) 30, and a home network end user (HNED) 40.

The HNED 40 may correspond to a client 100 that is an image display device according to an embodiment of the present invention, and the client 100 may be a network TV, a smart TV, and an IPTV, for example.

The content provider 10 produces and provides various content and may be a terrestrial broadcaster, a cable system operator (SO) or multiple system operator (MSO), a satellite broadcaster, or an Internet broadcaster as shown in FIG. 1.

The content provider 10 may provide various applications in addition to broadcasting content. Regarding this, a description will be provided below in more detail.

The service provider 20 may make and provide content provided by the content provider 10 as a service package. For example, the service provider 20 may make a first terrestrial broadcasting program, a second terrestrial broadcasting program, a cable MSO broadcasting program, various internet broadcasting programs, and applications as a package and provide the package to a user.

The service provider 20 may provide a service to the client 100 side by using a unicast or multicast mechanism.

The unicast mechanism indicates transferring data one to one between one transmitter and one receiver, and in the case of the unicast mechanism, a server may transfer data to the receiver in response to a request if the receiver requests the server to send data.

The multicast mechanism indicates transferring data to multiple receivers in a specific group, and for example, the server may simultaneously transfer data to multiple receivers that are pre-registered. An internet group management protocol (IGMP) may be used for such a multicast registration.

The network provider 30 may provide a network for providing such a service to the client 100, and use a service by using a home network end user (HNED).

To protect content transferred from such a system, conditional access or content protection may be used. As an example of the conditional access or the content protection, a cablecard, a downloadable conditional access system (DCAS), etc. may be used.

The client 100 may also provide content over a network, and in this case, the client 100 may be a content provider and the content provider 10 may receive content from the client 100. Accordingly, a bidirectional content service or data service may be possible.

According to an embodiment of the present invention, the content provided from the content server 100 may be any data file or software including data, moving picture, audio files or applications. The data may include any content provided from the content providing server 10.

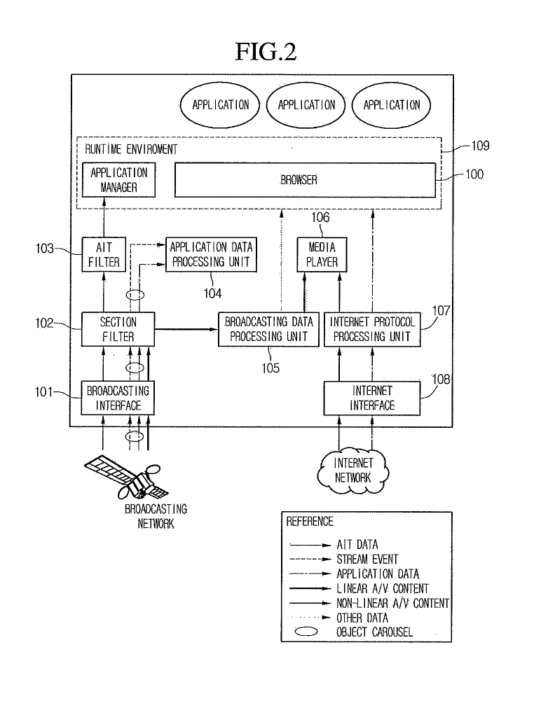

Referring to FIG. 2, an image display device 100 corresponding to the client as shown in FIG. 1 may be connected to a broadcasting network or the internet.

For example, the image display device 100 may include a broadcasting interface 101, a section filter 102, an application information table (AIT) filter 103, an application data processing unit 104, a broadcasting data processing unit 105, a media player 106, an internet protocol processing unit 107, an internet interface 108, and a run time module.

The broadcasting interface 101 of the image display device 100 may receive AIT data, live broadcast content, application data or stream events, and the live broadcast content may be a linear audio/visual (A/V) content.

The section filter 102 may perform section filtering on four kinds of data received through the broadcasting interface 101, and transfer the AIT data to the AIT filter 103, the linear A/V content to the broadcasting data processing unit 105, the stream event and application data to the application data processing unit 104.

The internet interface 108 may receive non-linear A/V content and application data, and for example, the non-linear A/V content may be content on demand (COD).

The non-linear A/V content may be transferred to the media player 106, and the application data may be transferred to the run time module 109.

In addition, the run time module 109 may include an application manager and a browser, and the application manager may control a life cycle for an interactive application by using the AIT data, and the browser may display and process the interactive application.

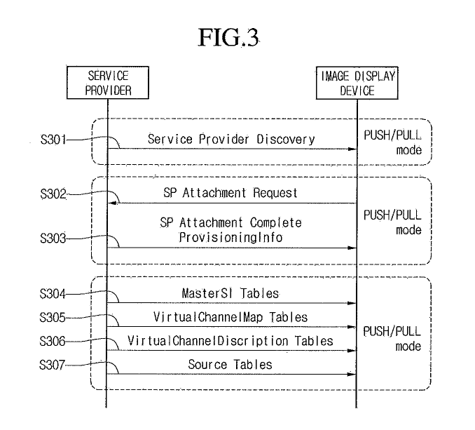

FIG. 3 represents a method of receiving/transmitting data between an image display device and a service provider according to an embodiment.

Referring to FIG. 3, the service provider performs a service provider discovery operation in step S301. The image display device transfers an SP attachment request signal in step S302. If the SP attachment is completed, the image display device receives provisioning information in step S303. Further, the image display device receives, from the service provider, a master SI table in step S304, a virtual channel map table in step S305, a virtual channel description table in step S306, and a source table in step S307.

For example, the service provider discovery may indicate the process in which service providers providing an IPTV relater service discovers a server that provides information regarding their service.

The ways of discovering an address list from which information regarding a service discovery (SD) server (for example, SP discovery information) may be obtained may be as follows. Firstly, an address preset in the image display device or an address set by user's manual operation may be used. Secondly, a dynamic host configuration protocol (DHCP) based SP discovery technique may be used. Thirdly, a DNS SRV-based SP discovery technique may be used.

In addition, the image display device may access a server corresponding to an address obtained by any one of the three techniques, receive a service provider discover record that contains information required for service discovery according to a SP, and search for a service by using the record. These processes may be possible in both a push mode and a pull mode.

The image display device may access an SP attachment server that is designated as an SP attachment locator of the SP discovery record, and perform a registration procedure (or a service attachment procedure).

In addition, the image display device may access an authentication service server of an SP designated as the SP authentication locator, perform a separate authentication procedure, and then perform a service authentication procedure.

After the service attachment procedure succeeds, data transferred from the server to the image display device may have a provisioning information table form.

In the service attachment process, the image display device may add its ID and positional information to data to be transferred to the server and the service attachment server may specify, based on them, a service which the image display device joins.

Address information from which the image display device may obtain service information may be provided in the form of the provisioning information table. The address information may correspond to access information in the master SI table and in this case, it is easy to provide a subscriber customized service.

In addition, the service information may include a master SI table record that manages access information and version of a virtual channel map, a virtual channel map table that provides a service list of a package form, a virtual channel description table that includes detailed information of each channel, and a source table that includes access information enabling access to an actual service.

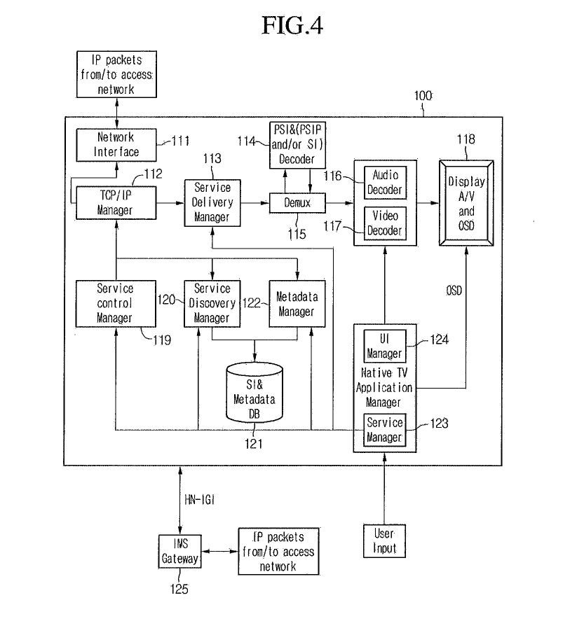

FIG. 4 is a schematic block diagram of an image display device according to an embodiment of the present invention.

Referring to FIG. 4, the image display device 100 may include a network interface 111, a TCP/IP manager 112, a service delivery manager 113, a demux 115, a PSI& (PSIP and/or SI) decoder 114, an audio decoder 116, a vide decoder 117, a display A/V and OSD module 118, a service control manager 119, a service discovery manager 120, a metadata manager 122, a SI& metadata DB 121, a UI manager 124, and a service manager.

The network interface 111 may receive packets from a network and transfer the packets to the network. That is, the network interface 111 may receive services and content from a service provider through the network.

The TCP/IP manager 112 may participate in delivering packets between a source and a destination that are received by and transmitted from the image display device 100. In addition, the TCP/IP manager 112 may classify the received packets according to a protocol and output the classified packets to the service delivery manager 115, the service discovery manager 120, the service control manager 119, and the metadata manager 122.

The service delivery manager 113 may be responsible for controlling received service data and use RTP/RTCP if controlling real-time streaming data for example.

When transmitting the real-time streaming data by using RTP, the service delivery manager 113 may parse the received data packet according to the RTP and then transmit the result to the de-multiplexer 115 or store the result on the SI& metadata DB 121 according to control of the service manager 123. In addition, the service delivery manager 113 may use RTCP to feed network reception information back to a server side that provides a service.

The de-multiplexer 115 may de-multiplex the received packet into audio, video, or program specific information (PSI) data and then transmit each of the de-multiplexed data to the audio and video decoders 116 and 117, and the PSI& (PSIP and/or SI) decoder 114.

The PSI& (PSIP and/or SI) decoder 114 may decode service information such as PSI. For example, it may receive and decode the PSI section de-multiplexed by the de-multiplexer 115, a program and service information protocol (PSIP) section or a service information (SI) section.

In addition, the PSI& (PSIP and/or SI) decoder 114 may decode the received sections, make a database regarding service information, and then store the database regarding the service information in the SI& metadata DB 121.

The audio and video decoders 116 and 117 may decode video and audio data received from the de-multiplexer 115 and provide the decoded audio and video data to a user through the display unit 118.

The UI manager 124 and the service manager 123 may manage the overall status of the image display device 100, provide a user interface, and manage other managers.

For example, the UI manager 124 may provide a graphic user interface (GUI) for a user by using an on screen display (OSD) and receive a key input from the user to perform an operation of a receiver according to the input. In addition, the UI manager 124 may transmit a signal related to a key input to the service manager 123 if receiving the key input related to channel selection from the user.

The service manager 123 may control service-related managers such as the service delivery manager 113, the service discovery manager 120, the service control manager 119, and the metadata manager 122.

In addition, the service manager 123 may make a channel map and select a channel by using the channel map according to the key input that is received from the UI manager 124,

In addition, the service manager 123 may receive service information regarding a channel from the PSI& (PSIP and/or SI) decoder 114 and set an audio/video packet identifier (PID) of the selected channel to the de-multiplexer 115.

The service discovery manager 120 may provide information required for selecting a service provider that provides a service. For example, the service discovery manager 120 may discover a service by using a received signal if receiving a signal for channel selection from the service manger 123.

The service control manager 119 is responsible for selecting and controlling a service. In addition, it may select and control a service by using IGMP or RTSP if selecting a live broadcasting service of a typical broadcasting type and by using RTSP if selecting a video on demand (VOD) service for example.

The RTSP protocol may provide a trick mode for real-time streaming, and the service control manager 119 may initiate and manage a session through an IMC gateway by using IP multimedia subsystem (IMS) and session initiation protocol (SIP).

The metadata manager 122 may manage service-related metadata and store the metadata in the SI& metadata DB 711.

In addition, the SI& metadata DB 121 may store service information decoded by the PSI& (PSIP and/or SI) decoder 114, metadata managed by the metadata manager 122, and information that is required for selecting a service provider provided by the service discovery manager 120.

In addition, the SI& metadata DB 121 may store setup data for a system and may be implemented as a nonvolatile RAM (NVRAM) or a flash memory for example.

An IG 750 may be a gateway that includes functions required for accessing an IMS based IPTV service.

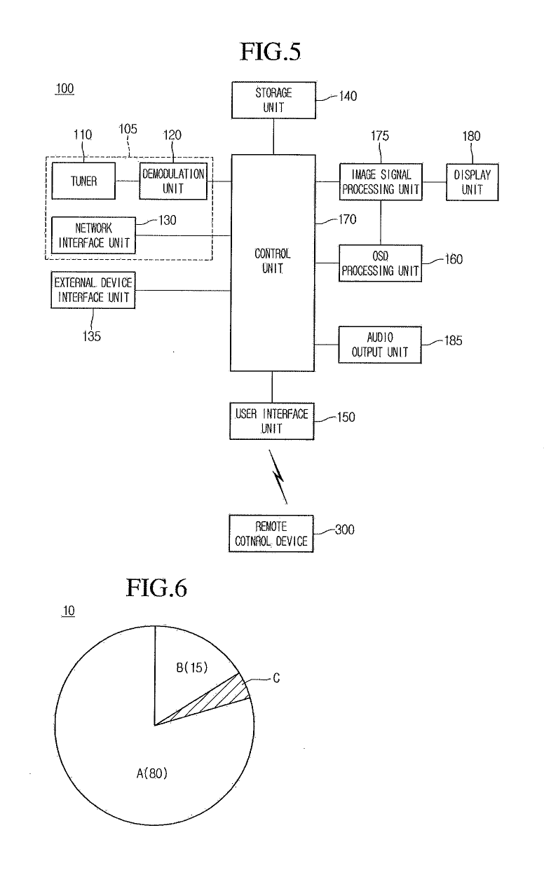

FIG. 5 is a schematic block diagram of an image display device according to another embodiment of the present invention.

FIG. 5 is a schematic block diagram of an image display device according to an embodiment of the present invention. Referring to FIG. 5, an image display device 100 according to an embodiment of the present invention may include a storage unit 140 that stores memory management data for a plurality of accounts, a user interface unit 150 that receives a command to store data selected in a state logged-in by one account, a control unit (170) that obtains information regarding the one account from the memory management data and allows a memory management menu to be displayed according to the information regarding the one account, a display unit 180 that displays an image processed according to control of the control unit, and a communication unit 105 that receives the data selected by a user and information related to this.

The communication unit 105 may receive an application or content from an IPTV service provider, a content provider, or any service provider that provides a VOD service. The received content may include movies, advertisements, games, VODs, broadcasting content and related information. The application may include a game, a software program, etc.

In the case that the content received through the communication unit 105 is related to digital broadcasting, a digital broadcasting signal received through a tuner 110 may be transmitted as a transport stream format that is produced by time-division multiplexing and packetizing a video signal, an audio signal, and additional data.

In addition, the data or content that is received through the communication unit 105 may be a data packet that is transmitted through a network interface unit 130.

The communication unit 105 may include a tuner that receives a transport stream such as a broadcasting signal transmitted from the outside such as an IPTV service provider, a content service provider, a cable network, etc., a demodulation unit 120 that outputs a broadcasting signal of a tuned specific channel as a transport stream format through a vestigial sideband (VSB) demodulation process and an error correction process, and the network interface unit 130 that receives content through a network.

A broadcasting signal that is received through the tuner 110 is divided into various kinds of additional data by a de-multiplexing unit (not shown), the additional data being defined as a video signal, an audio signal, and program and system information protocol (PSIP) information. The de-multiplexing unit may be implemented in the control unit 170.

In addition, the tuner 110 may receive a single-carrier RF broadcasting signal conforming to the advanced television system committee (ATSC) standard or a multi-carrier RF broadcasting signal conforming to the digital video broadcasting standard.

The tuner may sequentially select some of RF broadcasting signals received through an antenna that are from all broadcasting channels stored through a channel storage function, and may covert them into an intermediate frequency signal or a baseband image or audio signal.

The demodulation unit 120 receives a digital IF (DIF) signal converted by the tuner and demodulates the received signal.

For example, in the case that the DIF signal output from the tuner conforms to the standard ATSC, the demodulation unit performs, for example, 8-VSB demodulation. In addition, the demodulation unit may perform channel decoding. To this end, the demodulation unit may include a trellis decoder, a de-interleaver, and a Reed Solomon decoder to perform trellis decoding, de-interleaving, and Reed Solomon decoding.

For example, in the case that the DIF signal output from the tuner 110 conforms to the standard DVB, the demodulation unit performs, for example, coded orthogonal frequency division modulation (COFDMA) demodulation. In addition, the demodulation unit may perform channel decoding. To this end, the demodulation unit may include a convolution decoder, a de-interleaver, and a Reed-Solomon decoder to perform convolution decoding, de-interleaving, and Reed Solomon decoding.

The demodulation unit 120 may output a stream signal (TS) after performing the demodulation and the channel decoding. In this case, the stream signal may be a signal that an image signal, a audio signal or a data signal is multiplexed. For example, the stream signal may be an MPEG-2 transport stream (TS) that an MPEG-2 image signal, a Dolby AC-3 audio signal, etc are multiplexed.

For example, the TS signal may be an MPEG-2 TS in which an MPEG-2 image signal, a Dolby AC-3 audio signal, etc. are multiplexed. Specifically, the MPEG-2 TS may include a 4-byte header and a 184-byte payload.

The demodulation unit 120 may include both a demodulation unit conforming to the standard ATSC and a demodulation unit conforming to the standard DVB. That is, the demodulation unit 120 may include an ATSC modulation unit and a DVB demodulation unit.

The TS signal output from the demodulation unit 120 may be input to the control unit 170. The control unit 170 performs de-multiplexing, image/audio signal processing, etc. and then outputs an image through the display unit 180 and audio through an audio output unit 185.

The network interface unit 130 provides an interface for connecting the image display device 100 to a wired/wireless network including the Internet network. The network interface unit 105 may include an Ethernet port for connection with a wired network. The network interface unit 130 may also use the communication standard such as wireless LAN (WLAN) (Wi-Fi), wireless broadband (Wibro), World Interoperability for Microwave Access (WiMax), or High Speed Downlink Packet Access (HSDPA) for connection with a wireless network.

The network interface unit 130 may also transmit or receive data to or from another user or another electronic device through a connected network or another network linked to the connected network. In particular, the network interface unit 130 may transmit some of content data from the image display device 100 to a user or an electronic device that is selected from pre-registered other users or other electronic devices.

The network interface unit 130 may connect to a predetermined web page through a connected network or another network linked to the connected network and may provide an internet web page. That is, it may connect to a predetermined web page through a network and transmit or receive data to or from a corresponding server. In addition, it may receive content or data that is provide by a content provider or a network operator. That is, the network interface unit 130 may receive content such as movies, advertisements, games, VOD, or broadcasting signals and information associated with the content provided by the content or network provider over a network. In addition, the network interface unit 130 may receive update information and update files of firmware provided by the network operator. In addition, the network interface unit 130 may transmit data to the Internet or content provider or to the network operator.

In addition, the network interface unit 130 according to the present invention may connect to a service server that provides content or an application, and may receive data selected by a user for downloading from the server.

In addition, the image display device according to an embodiment of the present invention may receive a live broadcast through the tuner 110 and simultaneously receive data selected while being connected by one account through the network interface unit 130.

An external device interface unit 135 may connect to an external device and the image display device 100. To this end, the external device interface unit 135 may include an A/V input/output unit (not shown) or a wireless communication unit (not shown).

The external device interface unit 135 may be connected to the external device (not shown) such as a Digital Versatile Disk (DVD) player, a Blu-ray player, a game console, a camcorder or a (notebook) computer in a wired/wireless manner. The external device interface unit 135 delivers an image signal, an audio signal or a data signal received from the outside through a connected external device, to the control unit 170 of the image display device 100. In addition, the image, audio or data signal processed by the control unit 170 may be output to the connected external device. To this end, the external device interface unit 135 may include an A/V input/output unit (not shown) or a wireless communication unit (not shown).

The A/V input/output unit may include a Universal Serial Bus (USB) port, a Composite Video Banking Sync (CVBS) terminal, a component terminal, an S-video terminal (analog), a Digital Visual Interface (DVI) terminal, a High Definition Multimedia Interface (HDMI) terminal, an RGB terminal, and a D-SUB terminal to be able to input the image signal and the audio signal from the external device to the image display device 100.

According to an embodiment of the present invention, a method of managing a memory according to the present invention may also be applied to data received from the external device interface unit.

The wireless communication unit may perform wireless Local Area Network (LAN) communication with another electronic device. The image display device 100 may include hardware conforming to the communication standard such as Bluetooth, Radio Frequency Identification (RFID), Infrared Data Association (IrDA), Ultra Wideband (UWB), ZigBee, or Digital Living Network Alliance (DLNA).

In addition, the external device interface unit 135 may be connected to various set-top boxes through at least one of the above-described various terminals so as to perform an input/output operation with the set-top boxes.

The external device interface unit 135 may receive an application or a list of applications in a neighboring external device and deliver it to the control unit 170 or the storage unit 140.

The storage unit 140 may store a program for performing signal processing and control in the control unit 170 and also store a signal processed image, audio or data signal.

In addition, the storage unit 140 may perform a function to temporarily store an image, audio or data signal input from the external device interface unit 135 or the network interface unit 130. In addition, the storage unit 140 may store information regarding predetermined broadcasting channels through a channel storage function.

In addition, the storage unit 140 may store an application or a list of applications that is input from the external device interface 135 or the network interface unit 130. The storage unit 140 according to the present invention may store data selected and downloaded by a user, by at least one of a plurality of accounts. The storage unit 140 may store data by storage capacity allocated to a plurality of accounts. The storage unit 140 may store memory management data according to the present invention. The memory management data may include data regarding storage capacities allocated to a plurality of accounts and an in-use storage capacity by account.

The storage unit 140 may include a storage medium that has at least one of a flash memory type, a hard disk type, a multimedia card micro type, a card memory (e.g., SD memory, XD memory, etc.) type, a RAM type, and a ROM (EEPROM or the like) type. The image display device 100 may reproduce and provide a content file (such as a moving image file, a still image file, a music file, a document file, an application file, etc) from the storage unit 140 to the user.

FIG. 5 shows an embodiment where the storage unit 140 is configured separately from the control unit 170, but the scope of the present invention is not limited thereto. The storage unit 140 may be included in the control unit 170.

The user input interface unit 150 delivers a signal input by the user to the control unit 170 or delivers a signal from the control unit 170 to the user.

For example, the user input interface unit 150 may receive and process a control signal, such as power on/off, channel selection or screen setup, from a remote control device (not shown) such as a remote control or may transmit a control signal from the control unit 170 to the remote control device, according to various communication schemes such as a Radio Frequency (RF) communication scheme or an Infrared (IR) communication scheme.

In addition, for example, the user input interface unit 150 may deliver a control signal input through a local key (not shown) such as a power key, a channel key, a volume key, or a setup value to the control unit 170.

In addition, for example, the user interface unit 150 may deliver a control signal input from a sensing unit (not shown) for sensing user's gesture to the control unit 170 or transmit a signal from the control unit 170 to the sensing unit (not shown). In this case, the sensing unit (not shown) may include a touch sensor, a voice sensor, a position sensor, a motion sensor, etc.

The user interface unit 150 according to the present invention may receive a data selection command from a user. The data selection command from the user may be a command to select data, content or an application which the user wants to download, while the user logs in by using one account. The user interface unit 150 may receive a selection command from another account when the user changes from one account to another account and then stores data.

In addition, the user interface unit 150 may receive the same or different storage capacities allocated to a plurality of accounts, from the user.

The control unit 170 may de-multiplex a stream input through the tuner, the demodulation unit or the external device interface unit or may process a de-multiplexed signal to produce and output a signal for an image or audio output.

The image signal processed by the control unit 170 may be input to the display unit 180 such that an image corresponding to that image signal, such as an image corresponding to a memory management menu according to the present invention is displayed. In addition, the image signal processed by the control unit 170 may also be input to an external output device through the external device interface unit 135. In the case that the image display device 100 is configured as a set top box, the image signal processed by the control unit 170 may be transmitted to an external display through the external device interface unit 135.

The audio signal processed by the control unit 170 may also be audibly output to the audio output unit 185. In addition, the audio signal processed by the control unit 170 may be input to an external output device through the external device interface unit 135.

Furthermore, the control unit 170 may control the overall operation of the image display device 100. For example, the control unit 170 may control the tuner to tune to an RF broadcast corresponding to a channel selected by the user or a pre-stored channel.

In addition, the control unit 170 may control the image display device 100 by using a user command input through the user interface unit 150 or an internal program. In particular, the control unit 170 may connect to a network and allow a user to download a desired application or a desired list of applications in the image display device 100.

For example, the control unit 170 controls the tuner to receive a signal of a channel selected according to a predetermined channel selection command received through the user input interface unit 150. The control unit 170 then processes the image, audio or data signal of the selected channel. The control unit 170 may allow information regarding the channel selected by a user to be output through the display unit 180 or the audio output unit 185 together with the image or audio signal.

In another example, the control unit 170 may allow an image or audio signal received from an external device, for example, a camera or a camcorder, through the external device interface unit 135 to be output through the display unit 180 or the audio output unit 185 according to an external device image reproduction command received through the user input interface unit 150.

The control unit 170 may control the display unit 180 to display an image. For example, the control unit 170 may allow a broadcasting image input through the tuner 110, an external input image input through the external device interface unit 130, an image input through, a network interface unit 135, or an image stored in the storage unit 140 to be displayed on the display 180. In this case, the image displayed on the display unit 180 may be a still image, a moving image, a 2D image or a 3D image.

In addition, the control unit 170 may control content for reproduction. In this case, the content may be content stored in the image display device 100, received broadcasting content, or external input content input from the outside. The content may be at least one of a broadcasting image, an external input image, an audio file, a still image, a connected web screen, and a document file.

The control unit 170 according to the present invention may obtain memory management data, and obtain information regarding one logged-in account, such as data regarding a free storage capacity if a user inputs a command to store data. In addition, after determining whether the free storage capacity of the one account is sufficient or insufficient to download data, the control unit 170 may inform the user if the free storage capacity of the one account is insufficient. In addition, the control unit 170 may provide a memory management menu to select storage using another account while informing of the free storage capacity. In addition, after the user selects another account, the control unit 170 may provide a log-in menu for that account, accept a log-in procedure, and then allocate selected data to the another account. After the user stores data in the one account with which the user is currently logged-in, or in the another account, the control unit 170 may update memory management data.

FIG. 6 is a graph of a memory usage state by account of an image display device. It is assumed that the total storage capacity of the memory illustrated in FIG. 6 is 100 Gigabyte. Referring to FIG. 6, a user corresponding to account A is using a storage capacity of 80 Gigabyte and another account B is using 15 Gigabyte. Since the free capacity of the memory 10 is just 5 Gigabyte, there is a limitation in that a user corresponding to account C may not download a 10 Gigabyte application.

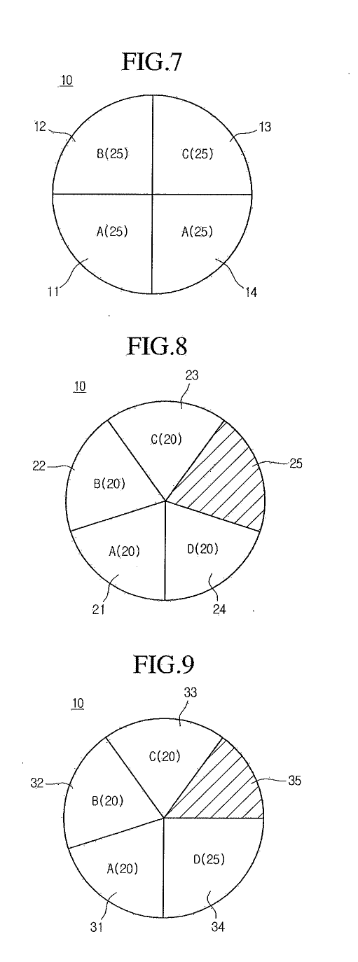

FIG. 7 is a graph of a memory usage state of memory management data according to an embodiment of the present invention. FIG. 7 shows that a storage capacity of 25 Gigabyte is allocated to each of four accounts according to an embodiment of the present invention. The number in a round bracket indicates a storage capacity. Although the storage capacity of 25 Gigabyte may be defined as a minimum storage capacity, it may also be defined as a maximum storage capacity by account because 100 Gigabyte all is allocated to the accounts in FIG. 7. The storage capacity by account may vary. In the case that the storage capacity by account does not change, a user with an account may use only the allocated storage capacity.

FIG. 8 is a graph of a memory usage state of memory management data according to another embodiment of the present invention. Referring to FIG. 8, 20 Gigabyte is allocated to a region 21 for account A, 20 Gigabyte is allocated to a region 22 for account B, 20 Gigabyte is allocated to a region 23 for account C, and 20 Gigabyte is allocated to a region 24 for account D. Thus, a region 25 of the memory 10 may be configured as a memory region to which any account is not allocated. Such a region 25 may be a sharing memory region. For example, if a user downloads data without logging in by any account, the data may be downloaded in the sharing memory region 25. The other regions 21 to 24 may be defined as a personal memory region.

FIG. 9 is a graph of a memory usage state of memory management data according to another embodiment of the present invention. Referring to FIG. 9, 20 Gigabyte, 20 Gigabyte, 20 Gigabyte, and 25 Gigabyte are allocated to personal memory regions 31 to 34, respectively. That is, storage capacities by account in the memory management data may be different as shown in FIG. 9. In the case that a user corresponding to account D downloads much data in the image display device and thus needs more memory than other users corresponding to other accounts, or in the case that any user does not store data in the image display device, it is possible to differently set a storage capacity by account so as to increase the efficiency of memory management. If necessary or in the case that the allocated personal memory region is insufficient, it is possible to further allocate a sharing memory region 35 to a corresponding account. That is, the storage capacity by account of memory management data according to the present invention may be further expanded as long as there is a storage space corresponding to a sharing memory region.

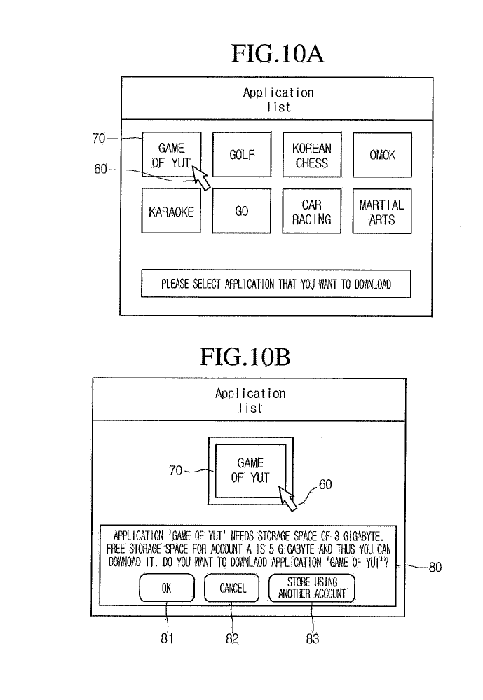

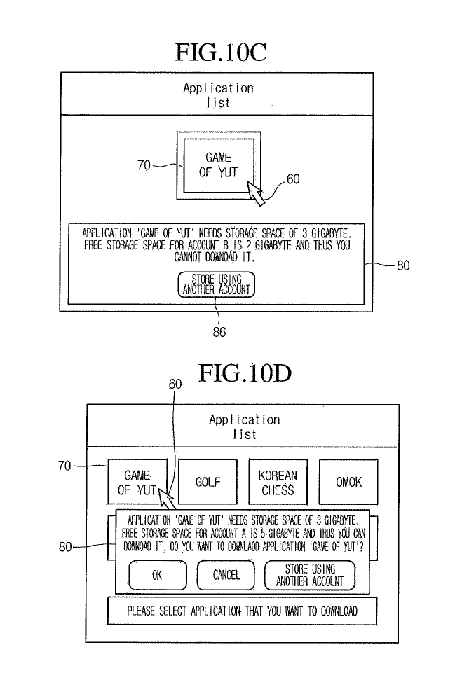

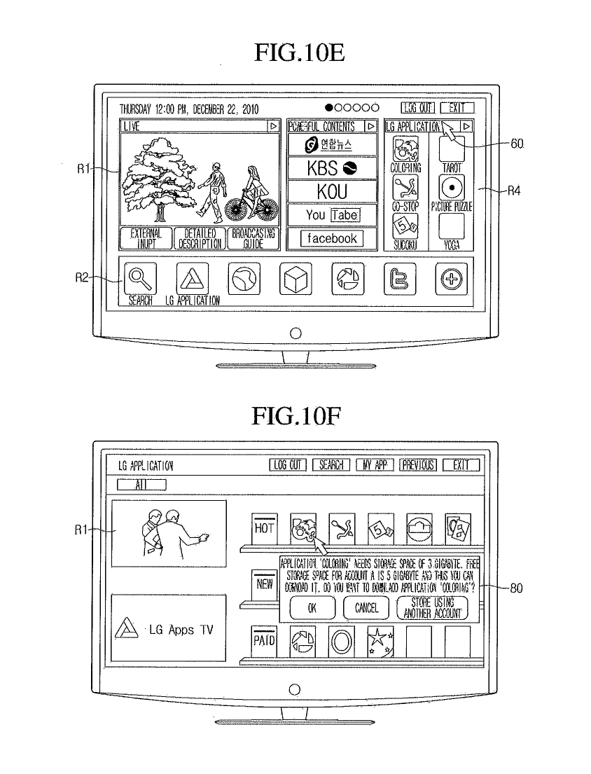

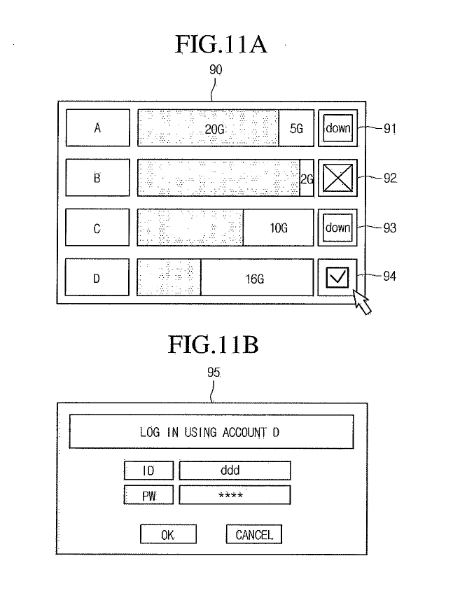

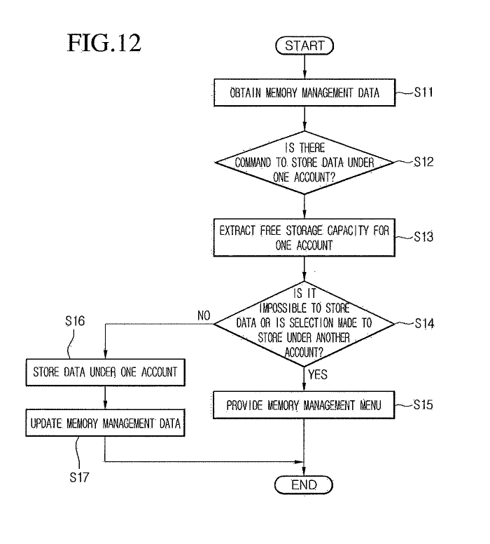

FIG. 10A is an exemplary screen of how to select data to be downloaded by a user. Referring to FIG. 10A, a user who logs in by using account A is selecting an application 70 to be downloaded by using a pointer 60. That is, while the user logs in by using one account according to an embodiment of the present invention, a command to store the selected data is being input.

FIG. 10B is an exemplary screen of how to inform a user of a memory usage state by using memory management data. The image display device may provide a memory inform menu 80 that may obtain the memory management data before downloading an application, check the storage capacity of account therein, and inform a user of the storage capacity by account. The user may select an OK button 81 to continue to download data by using one account, or may select a CANCEL button 82 to cancel downloading. In addition, by selecting a STORE USING ANOTHER ACCOUNT button 83, it is possible to search for another account that has a sufficient storage capacity. That is, if the user wants to store the selected data, it is possible to check a storage capacity state of a corresponding account and give caution to the user. Thus, the present invention may allow the user to use data as planned, the user recognizing that a storage capacity corresponding to his/her account is insufficient. In addition, if a storage capacity corresponding to that account is insufficient, it is possible to provide a chance to store data by using another account.

FIG. 10C is an exemplary screen of how to inform of a lack of memory of one account. Referring to FIG. 10C, it illustrates a case where a user wants to store data even though a storage capacity for account B is insufficient. The image display device may provide a memory lack inform menu 85 that informs the user of a situation if it is determined that a storage space of the selected data for account B is insufficient. Accordingly, the present invention may allow the user to select a STORE USING ANOTHERACCOUNT button 86.

When the user selects an application while the list of applications of FIG. 10A is displayed, the memory inform menu 80 and the memory lack inform menu 85 that are described with respect to FIGS. 10B and 10C may be displayed along with the list of applications. FIG. 10D is an exemplary screen of how to display a memory inform menu 80 along with an application list screen

FIG. 10E is a screen of an image display device according to another embodiment of the present invention. Referring to the right upper end of FIG. 10A, it may be seen that a user logs in by using an account, for example, account A. Referring to FIG. 10E, there are a first region R1 where a live broadcast received through a tuner while the image display device is logged in is displayed and a second region R2 where an application downloaded by a user corresponding to a logged-in account is displayed. The first, the second, a third, and a fourth region indicates a portion of a screen of the image display device. In addition, there may also be a third region R3 where a list of content providers available to the user corresponding to the logged-in account is displayed and a fourth region R4 where an application store such as “LG app” in which an application may be purchased or downloaded is displayed. That is, the image display device according to an embodiment of the present invention may be logged in by using one account and then display the list of applications downloaded by a user along with the live broadcast on the second region R2.

In FIG. 10E, the user connects to an application distribution site such as “LG app” by using a pointer 60 while being logged-in by using one account.

FIG. 1OF is an exemplary screen of how to enter a data store command according to an embodiment of the present invention. Referring to FIG. 10F, a live broadcast is displayed in a first region R1, and a plurality of lists of applications which a user may select are simultaneously displayed on portions of a screen other than the first region R1. As shown in FIG. 10F, the first region R1 is smaller than that of FIG. 10E and thus more applications may be displayed on a screen of an image display device. That is, unlike FIG. 10A, a list of data that the user may select may be displayed on a part of the screen without being displayed on the full screen of the image display device and the live broadcast may be simultaneously displayed on the first region R1 that is another part of the screen, in FIG. 10F. Accordingly, the user may check and select a list of applications to be downloaded while viewing the live broadcast. As illustrated in FIG. 10F, if the user selects the application ‘coloring’, the above-described memory management menu 80 may be displayed along with the live broadcast.

That is, according to an embodiment of the present invention, if the user wants to store selected data, a memory management menu related to that data may be displayed along with or independently of the live broadcast.

FIG. 11A is an example of a memory management menu according to an embodiment of the present invention. If a user corresponding to account A with a sufficient storage capacity selects the STORE USING ANOTHER ACCOUNT button 83 in FIG. 10B, or if there is selection by user B with a insufficient storage capacity in FIG. 10C, the image display device according to the present invention may provide a memory management menu 90. Referring to FIG. 11A, the memory management menu 90 may provide a storage capacity allocated by account, a in-use storage capacity by account, and a free storage capacity on the basis of memory management data. FIG. 11A illustrates that a storage capacity of 25 Gigabyte is allocated to each of accounts A to D, and a free storage capacity of the account A is 5 Gigabyte, a free storage capacity of the account B is 2 Gigabyte, a free storage capacity of the account C is 10 Gigabyte, and a free storage capacity of the account D is 16 Gigabyte. The memory management menu 90 may include interfaces 91, 92, and 94 for storing data selected by some of a plurality of accounts. Since a storage capacity for the account B is insufficient, an interface corresponding to the account B is illustrated as inactivated. A user may select one account that is in a logged-in state or may store selected data by using another account. In FIG. 11A, storing in the account D is being selected.

FIG. 11B is an example of a log-in menu by using another account. As in the case of FIG. 11A, a user who uses the account A may select storing data in the account D, and if there is a log-in procedure using the account D, a log-in menu 95 may be provided. The user who uses the account A may obtain permission from another user who uses another account, enter his/her ID and password, and store selected data under the another account.

FIG. 12 is a flow chart of a method of managing a memory according to an embodiment of the present invention.

In step S11, memory management data according to a plurality of accounts is obtained.

In step S12, it is determined whether there is a data store command from a user who logs in using one account.

In step S13, information regarding the one account, such as data regarding a free storage capacity is obtained from the memory management data.

In step S14, it is determined whether a storage capacity for the one account is insufficient or the user selects storing under another account even if the storage capacity for the one account is sufficient.

In step S15, a memory management menu is provided. The user may determine with reference to the memory management data according to a plurality of accounts which of the plurality accounts stores selected data

In step S16, data is stored in the storage space for the one account.

In step S17, the memory management data is updated. In addition, even if the user stores data under another account, the memory management data may be updated.

The image display device and the method of managing a memory according to the present invention may not be limited to the configuration and method of the above-described embodiments but the embodiments may be configured by selective combination of all or some of the embodiments so that various variations may be made.

The method of managing the memory of the image display device according to the present invention can also be embodied as a processor readable code on a processor readable recording medium, the processor being included in the image display device. The processor readable recording medium is any data storage device that can store data which can be thereafter read by the processor. Examples of the processor readable recording medium include read-only memory (ROM), random-access memory (RAM), CD-ROMs, magnetic tapes, floppy disks, and optical data storage devices, and also includes being implemented as a carrier wave form such as transmission through the Internet). In addition, the processor readable recording medium can also be distributed over network coupled computer systems so that the processor readable code is stored and executed in a distributed fashion.

In addition, although exemplary embodiments have been illustrated and described above, the present disclosure is not limited specific embodiments described above but may be varied by those skilled in the art without departing from the subject matter of the present disclosure claimed in the following claims. Further, these variations should not be understood individually from the technical spirit or perspective of the present disclosure.

1-25. (canceled)

26. A method of managing a memory according to a plurality of accounts on an image display device, the method comprising:
obtaining memory management data according to the plurality of accounts;
receiving a command to store selected data while logged in using one account among the plurality of accounts;
obtaining information regarding the one account; and
displaying a memory management menu according to the information regarding the one account.

27. The method of claim 26, further comprising:
displaying a live broadcast on a first region that is a part of a screen of the image display device; and
displaying a selectable data list on a second region that is a part of the screen of the image display device, and
wherein the memory management menu is displayed simultaneously with or independently of the live broadcast.

28. The method of claim 27, wherein the selectable data list comprises at least one of contents and an application and is received from a server.

29. The method of claim 26, wherein the memory management data includes data regarding a storage capacity being allocated per account, and data regarding an in-use storage capacity by account.

30. The method of claim 26, wherein the information regarding the one account includes data regarding a free storage capacity for the one account.

31. The method of claim 26, further comprising:
informing if a storage capacity for the selected data is insufficient under the one account.

32. The method of claim 26, further comprising:
receiving a command to select another account among the plurality of accounts.

33. The method of claim 32, further comprising:
providing the memory management menu if the command to select the another account is received.

34. The method of claim 26, wherein the memory management menu comprises an interface for storing the selected data under another account on the basis of the memory management data.

35. The method of claim 34, further comprising:
providing a log-in menu for the another account if selection is made for the another account.

36. The method of claim 26, further comprising:
storing the selected data; and
updating the memory management data according to the storing of the selected data.

37. The method of claim 26, wherein the memory management data includes data regarding a storage capacity being allocated per account, and
further comprising:
setting the storage capacities of the plurality of accounts to have the same or different capacities.

38. The method of claim 37, further comprising:
receiving the storage capacities allocated to the plurality of accounts.

39. An image display device for managing a memory according to a plurality of accounts, the image display device comprising:
a storage unit to store memory management data according to the plurality of accounts;
an user interface unit to receive a command to store selected data while logged in using one account among the plurality of accounts;
a control unit to obtain information regarding the one account from the memory management data and to display a memory management menu according to the information regarding the one account.

40. The image display device of claim 39, further comprising:
a display unit to display a live broadcast on a first region that is a part of a screen of the image display device and to display a selectable data list on a second region that is a part of the screen of the image display device, and
wherein the control unit allows the memory management menu to be displayed simultaneously with or independently of the live broadcast.

41. The image display device of claim 39, wherein the memory management data includes data regarding a storage capacity being allocated per account, and data regarding an in-use storage capacity by account.

42. The image display device of claim 39, wherein the information regarding the one account includes data regarding a free storage capacity for the one account, and
wherein the control unit to inform if a storage capacity for the selected data is insufficient under the one account.

43. The image display device of claim 39, wherein the memory management menu comprises an interface for storing the selected data under another account on the basis of the memory management data,
wherein the user interface unit to receive a command to select another account among the plurality of accounts, and
wherein the control unit to provide the memory management menu if the command to select the another account is received through the user interface unit and to provide a log-in menu for the another account if selection is made for the another account.

44. The image display device of claim 39, wherein the control unit to update the memory management data according to the storing of the selected data.

45. The image display device of claim 39, wherein the storage unit to include, in the memory management data, data regarding a storage capacity being allocated per account,
wherein the storage capacities are set to allow the plurality of accounts to have the same or different capacities, and
wherein the user interface unit to receive the storage capacities allocated to the plurality of accounts.
